(19) United States
(12) Patent Application Publication
(10) Pub. No.: US 2026/0243568 A1
(43) Pub. Date: Aug. 20, 2026

(54) MEASUREMENT SYSTEM AND MEASUREMENT METHOD

(71) Applicant: NTT, Inc., Tokyo (JP)

(72) Inventors: Shohei YAMASHITA, Tokyo (JP); Daisuke UCHIBORI, Tokyo (JP); Yosuke SAKURADA, Tokyo (JP)

(73) Assignee: NTT, Inc., Tokyo (JP)

(21) Appl. No.: 19/489,537

(22) PCT Filed: Jun. 2, 2023
(86) PCT No.: PCT/JP2023/020708

§ 371 Date: Dec. 2, 2025

(51) Int. Cl. G01C 15/00; G01C 3/02; G01C 15/04

(52) U.S. Cl. CPC G01C 15/006; G01C 3/02; G01C 15/008; G01C 15/04

(57) ABSTRACT

A measurement system (100) according to the present disclosure includes a first measurement device (10), a second measurement device (20), and an information processing device (30), in which: the first measurement device (10) includes a first laser range finder (11) and a panel (12) disposed at a first relative position with respect to the first laser range finder (11); the second measurement device (20) includes two position measurement instruments and a second laser range finder (22) that is disposed at a second relative position with respect to the two position measurement instruments, irradiates a distance measurement direction, and measures a distance; the information processing device (30) includes a calculation unit (32) that calculates an absolute position (P₀) of a target on the basis of the absolute positions of the two position measurement instruments, a vertical distance (Lₓ), a horizontal distance (L_{y}), a first relative position, and an orientation in a distance measurement direction of the second laser range finder.

### TECHNICAL FIELD

The present disclosure relates to a measurement system and a measurement method.

### BACKGROUND ART

Conventionally, a position of an underground buried object has been identified on the basis of a relative position from a reference point by using a road boundary or the like as the reference point. However, when a road shape changes due to a change in the road such as widening, the above reference point becomes unclear. This makes it difficult to identify the position of the underground buried object in some cases.

Therefore, a worker measures an absolute position of the underground buried object by using a GNSS receiver of a satellite navigation system (global navigation satellite system (GNSS)) and a ranging rod for each measurement point such that the position of the underground buried object can be identified even if the road shape changes. In such measurement, the workload of the worker increases as the measurement point increases.

In order to reduce such the workload, as described in Non Patent Literature 1, it is known that, when an underground buried object is laid, an absolute position of the underground buried object is measured by using a trencher to which a GNSS receiver is attached.

Specifically, as shown in FIGS. 9 and 10, a GNSS receiver 92 and a compass 93 are attached to a trencher 91. An absolute position of the GNSS receiver 92 is measured by using the GNSS receiver 92, and an orientation from the GNSS receiver 92 to a position P_{9A} of a blade edge of the trencher 91 is measured by using the compass 93. Then, the worker measures a horizontal distance Lₓ₉, from the GNSS receiver 92 to the position P_{9A} of the blade edge of the trencher 91, a height L_{y91} of the GNSS receiver 92 from a ground surface, and a depth L_{y92} of the ground excavated by the trencher 91 by using a scale. Therefore, a position, which is apart from the absolute position of the GNSS receiver 92 by the horizontal distance Lₓ₉ in the orientation measured by the compass 93 and is apart by the sum of the height L_{y91} and the depth L_{y92} in a vertical downward direction, is calculated as the position P_{9A} of the blade edge.

### CITATION LIST

### Non Patent Literature

Non Patent Literature 1: Takuya Ishikawa and two others, “Study on a method for highly accurate estimation of pipe laying position using excavation machine”, JSCE, Japan Society of Civil Engineers 2022 Annual Meeting

### SUMMARY OF INVENTION

### Technical Problem

However, the overall height of the general trencher 91 is 2 m or more, and thus it is difficult to attach the GNSS receiver 92 and the compass 93 on the center line of the blade of the trencher 91 on the trencher 91. Therefore, as shown in FIG. 10, the orientation measured by using the compass 93 (a direction of an arrow indicated by a broken line) may deviate from an orientation (x-axis direction) from the GNSS receiver 92 to the blade edge of the trencher 91. Therefore, a position P_{9B} apart by the horizontal distance Lₓ₉ in the erroneously measured orientation may be erroneously measured as the position P of the blade edge. It is difficult to measure the horizontal distance Lₓ₉, the height L_{y91}, and the depth L_{y92} described above by using the scale with high accuracy. Therefore, it is difficult to measure an absolute position of an underground buried object located at the blade edge of the trencher 91 with high accuracy in some cases.

An object of the present disclosure that has been made in view of such circumstances is to provide a measurement system and a measurement method capable of measuring an absolute position of a target corresponding to an underground buried object with high accuracy.

### Solution to Problem

In order to solve the above problem, a measurement system according to the present disclosure is a measurement system that includes a first measurement device, a second measurement device, and an information processing device and measures an absolute position of a target that is a first portion of a movable object, in which: the first measurement device includes a first laser range finder that irradiates a distance measurement direction and measures a distance, and a panel disposed at a first relative position with respect to the first laser range finder; the second measurement device includes two position measurement instruments that measure respective absolute positions by using signals received from a satellite and are disposed at different positions, and a second laser range finder that is disposed at a second relative position with respect to the two position measurement instruments, irradiates a distance measurement direction, and measures a distance; and the information processing device includes a calculation unit that calculates the absolute position of the target on the basis of the absolute positions of the two position measurement instruments, a vertical distance from the first laser range finder to the target measured by the first laser range finder, a horizontal distance from the second laser range finder to the panel measured by the second laser range finder, the first relative position, and an orientation in the distance measurement direction of the second laser range finder in a state in which the second laser range finder is attached to a second portion where a positional relationship with the first portion of the object does not change.

In order to solve the above problem, a measurement method according to the present disclosure is a measurement method using a measurement system for measuring an absolute position of a target that is a first portion of a movable object, the measurement method including: a step of installing a first measurement device including a first laser range finder and a panel disposed at a first relative position with respect to the first laser range finder such that the first laser range finder can measure a vertical distance from the target; a step of installing a second measurement device including two position measurement instruments that measure respective absolute positions by using signals received from a satellite and are disposed at different positions and a second laser range finder disposed at a second relative position with respect to the two position measurement instruments such that the second laser range finder can measure a horizontal distance from the panel; a step of measuring the vertical distance by the first laser range finder; a step of measuring the absolute positions of the two position measurement instruments; a step of measuring the horizontal distance by the second laser range finder; and a step of calculating the absolute position of the target on the basis of the absolute positions of the two position measurement instruments, the vertical distance from the first laser range finder to the target measured by the first laser range finder, the horizontal distance from the second laser range finder to the panel measured by the second laser range finder, the first relative position, and an orientation in a distance measurement direction of the second laser range finder.

### Advantageous Effects of Invention

A measurement system and a measurement method according to the present disclosure can measure an absolute position of a target corresponding to an underground buried object with high accuracy.

### BRIEF DESCRIPTION OF DRAWINGS

FIG. 1 schematically shows an example of a measurement system according to the present embodiment.

FIG. 2A is a front view showing a first measurement device of FIG. 1 in detail.

FIG. 2B is a side view showing the first measurement device of FIG. 2A in detail.

FIG. 3A is a plan view showing a second measurement device of FIG. 1 in detail.

FIG. 3B is a back view showing the second measurement device of FIG. 3A in detail.

FIG. 4 is a functional block diagram showing an example of an information processing device of FIG. 1.

FIG. 5A is a flowchart showing a part of an example of measurement using the measurement system according to the present embodiment.

FIG. 5B is a flowchart showing a remaining part of the example of the measurement using the measurement system according to the present embodiment.

FIG. 6A is a plan view showing a modification of the second measurement device according to the present embodiment in detail.

FIG. 6B is a back view showing a modification of the second measurement device of FIG. 6A in detail.

FIG. 7 is a schematic view showing an example of an excavation machine to which the second measurement device of FIGS. 6A and 6B is attached and which is inclined in a traveling direction.

FIG. 8 shows an example of a hardware configuration of an information processing device.

FIG. 9 is a side view schematically showing an example of a conventional measurement system.

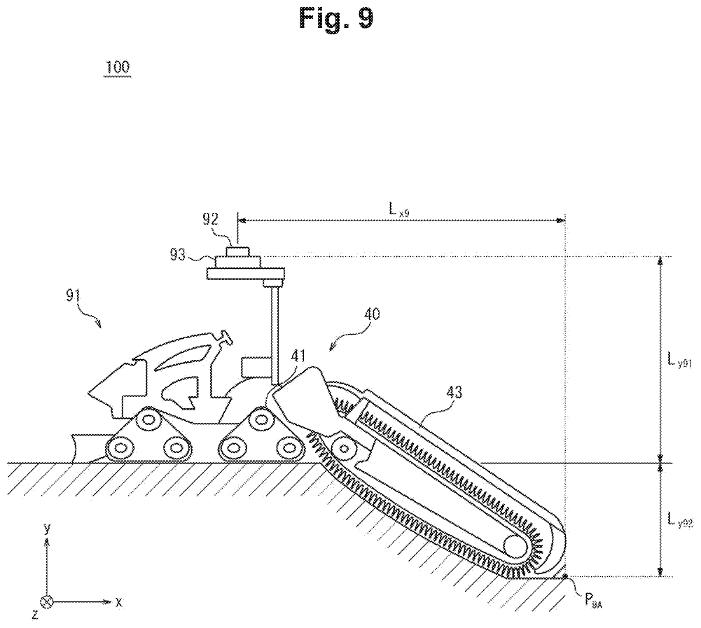

FIG. 10 is a plan view showing an example of the measurement system of FIG. 9.

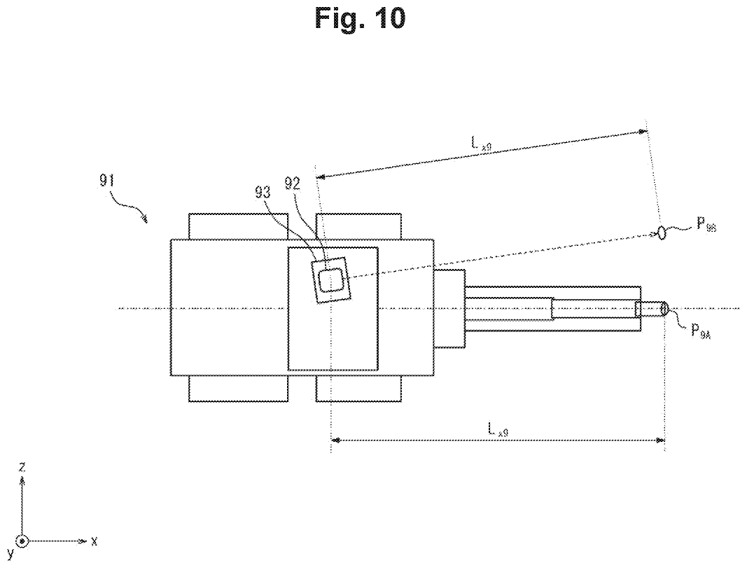

### DESCRIPTION OF EMBODIMENTS

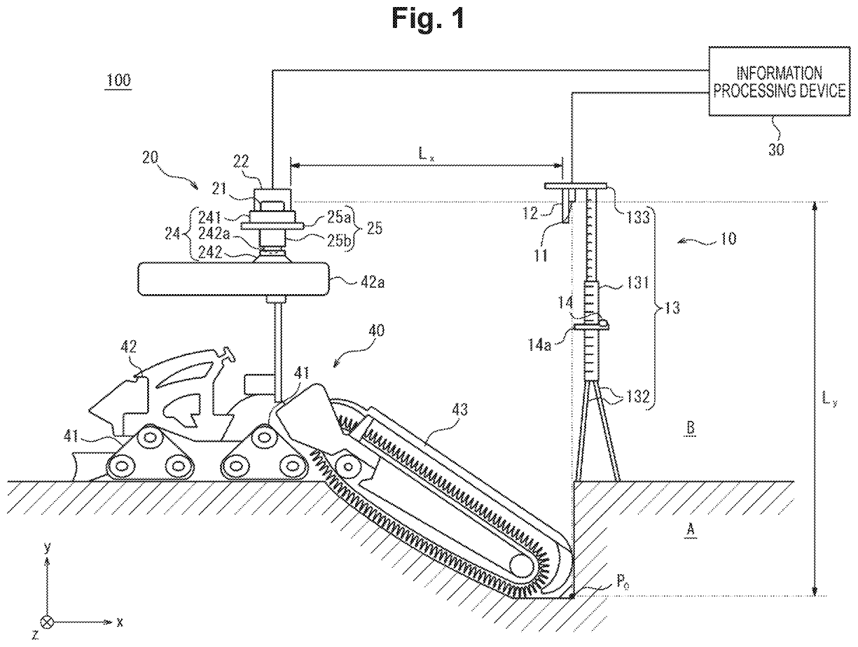

A measurement system 100 of the present embodiment will be described with reference to FIG. 1. As shown in FIG. 1, the measurement system 100 measures an absolute position Pc of a target that is a first portion of a movable object. The movable object can be, for example, an excavation machine 40 that excavates ground A. As an example, the excavation machine 40 can be a trencher. In a configuration in which the movable object is a trencher, the target that is the first portion may be a blade edge of the trencher. In such an example, the trencher excavates the ground A with the blade edge while traveling on ground B.

The excavation machine 40 includes traveling units 41, a main body unit 42, and a working unit 43.

The traveling unit 41 is, for example, a continuous tracked traveling device. The traveling unit 41 may include a drive wheel, an idler wheel, and a crawler wound around the drive wheel and the idler wheel. The traveling unit 41 moves in an extending direction on the ground B by driving the drive wheel to rotate the crawler in the extending direction.

The main body unit 42 is connected to the traveling units 41 on the traveling units 41. Therefore, the main body unit 42 moves with the movement of the traveling units 41. The main body unit 42 may include a driver's seat for a driver to sit in. The main body unit 42 may include an operation unit such as operation levers for operating the traveling units 41 and the working unit 43. A roof 42a may be provided above the main body unit 42.

The working unit 43 is attached to the main body unit 42. The working unit 43 can excavate the ground A while the main body unit 42 is traveling on the ground B. As described above, in a configuration in which the excavation machine 40 is a trencher, the first portion is the blade edge that is the tip end of the working unit 43.

The measurement system 100 includes a first measurement device 10, a second measurement device 20, and an information processing device 30.

### <Configuration of First Measurement Device>

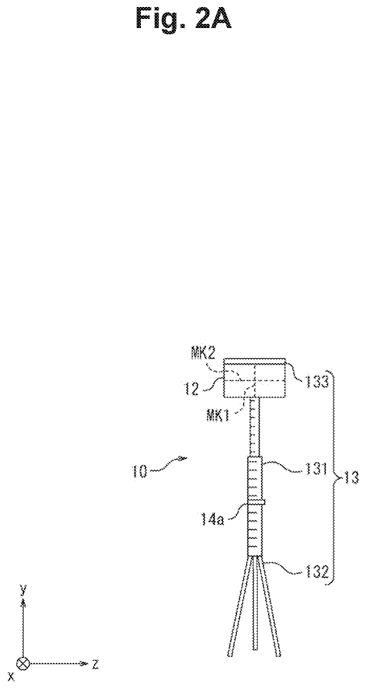

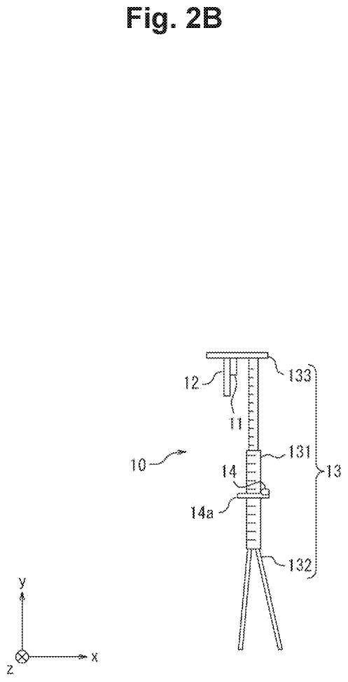

As shown in FIGS. 2A and 2B, the first measurement device 10 includes a first laser range finder 11, a panel 12, a first jig 13, and a level 14.

The first laser range finder 11 emits a first laser beam in a distance measurement direction and measures a distance. Specifically, the first laser range finder 11 has a function as a laser pointer that emits the first laser beam visible by humans and measures a distance from an irradiation position irradiated with the first laser beam.

The panel 12 is disposed at a first relative position with respect to the first laser range finder 11. When a laser beam is incident on the panel 12, the panel 12 can reflect the laser beam in a direction opposite to an incident direction of the laser beam. The panel 12 may indicate a position overlapping the origin of measurement in the first laser range finder 11 when the panel 12 is viewed from the normal direction. Specifically, the position may be indicated as an intersection between a vertical mark MK1 extending in a vertical direction and a horizontal mark MK2 extending in a horizontal direction. For example, when viewed from the normal direction of the panel 12, in a case where the origin of the measurement in the first laser range finder 11 overlaps an intersection between the center line extending in the vertical direction that divides the panel 12 into two parts in the horizontal direction and the center line extending in the horizontal direction that divides the panel 12 into two parts in the vertical direction, the vertical mark MK1 is the center line extending in the vertical direction, and the horizontal mark MK2 is the center line extending in the horizontal direction.

The first jig 13 can fix and support the first laser range finder 11 and the panel 12. The first jig 13 supports the panel 12 such that the panel 12 is disposed at the first relative position with respect to the first laser range finder 11. Thus, the first laser range finder 11 and the panel 12 are integrated.

For example, the first jig 13 supports the first laser range finder 11 such that the distance measurement direction of the first laser range finder 11 (a direction opposite to the y-axis direction in the example of FIGS. 2A and 2B) is an extending direction of the first jig 13. Thus, when the first jig 13 is installed such that the extending direction thereof is the vertical direction, the first jig 13 supports the first laser range finder 11 such that the distance measurement direction is the vertical direction. Therefore, the first laser range finder 11 can measure a vertical distance L_{y} that is a distance from the position P₀ of the target in the vertical direction.

The first jig 13 may be configured to change a distance from the ground surface to the panel 12. Because the panel 12 is disposed at the first relative position with respect to the first laser range finder 11 as described above, the first jig 13 may be configured to change not only the distance from the ground surface to the panel 12 but also a position of the first laser range finder 11. For example, the first jig 13 may be configured to be expandable and contractible in the extending direction and thus may change the positions of the first laser range finder 11 and the panel 12. The first jig 13 may be provided with a scale for measuring a distance in the extending direction.

In the example of FIGS. 2A and 2B, the first jig 13 includes a main column portion 131 extending in one direction, a support column portion 132 that can erect the main column portion 131 such that an extending direction of the main column portion 131 is the vertical direction, and a support portion 133 that is fixed to the main column portion 131 at an end of the main column portion 131 in the extending direction and supports the first laser range finder 11 and the panel 12.

The support column portion 132 may be, for example, a tripod. The support portion 133 may support the first laser range finder 11 and the panel 12 under the support portion 133 when the first jig 13 is erected. The support portion 133 may protrude from the panel 12 toward the first measurement device 10. Therefore, the protruding portion of the support portion 133 functions as an eave, and the irradiation position of the laser beam emitted by the first laser range finder 11 is easily visually recognized by a worker even outdoors during the day.

The level 14 indicates whether or not the distance measurement direction of the first laser range finder 11 is the vertical direction. For example, in a configuration in which the distance measurement direction of the first laser range finder 11 is the extending direction of the first jig 13 as described above, the level 14 may be attached to the first jig 13 by being placed on a planar member 14a having a plane whose normal direction is the extending direction of the first jig 13. In such a configuration, the level 14 can indicate whether or not the plane is horizontal. Therefore, the level 14 can indicate whether or not the extending direction of the first jig 13, which is the normal direction of the plane, is the vertical direction, that is, whether or not the distance measurement direction of the first laser range finder 11 is the vertical direction. When the level 14 is attached to the first jig 13 in such a manner, the first laser range finder 11, the panel 12, and the level 14 may be integrated.

### <Configuration of Second Measurement Device>

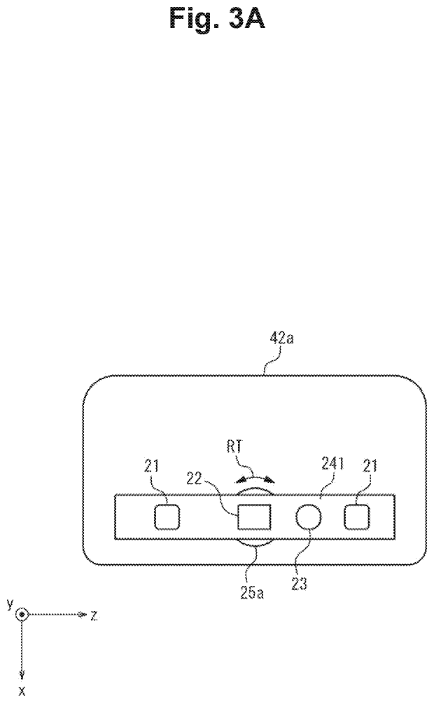

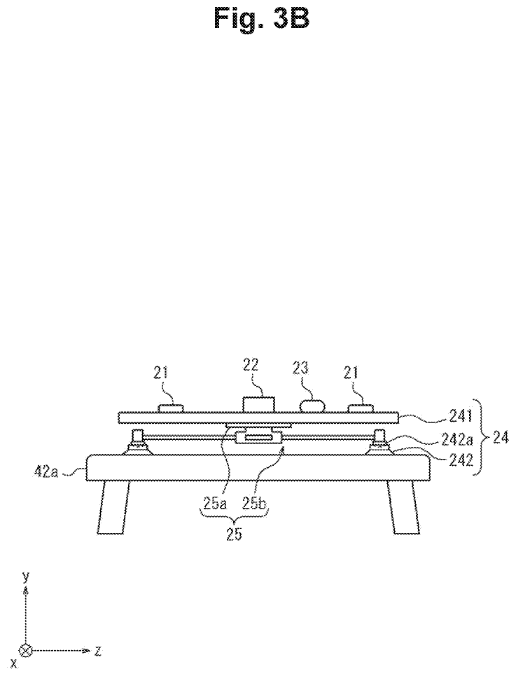

As shown in FIGS. 3A and 3B, the second measurement device 20 includes two position measurement instruments 21, a second laser range finder 22, an orientation measurement instrument 23, a second jig 24, and an adjustment mechanism 25. In the example of FIGS. 1 and 3A, the second measurement device 20 is attached onto the roof 42a of the main body unit 42 in the excavation machine 40. The second measurement device 20 may be attached to the excavation machine 40 by any method. The second measurement device 20 may be detachably attached to the excavation machine 40.

Returning to FIGS. 3A and 3B, the two position measurement instruments 21 measure their respective absolute positions by using signals received from a satellite. The two position measurement instruments 21 are disposed at different positions. The position measurement instrument 21 can be a GNSS receiver of a satellite navigation system (global navigation satellite system (GNSS)). The satellite can be a satellite of the satellite navigation system. The satellite navigation system can be a quasi-zenith satellite system (QZSS), a global positioning system (GPS), or the like. In such a configuration, the position measurement instruments 21 can measure the absolute positions by a known method by using GNSS signals received from a GNSS satellite.

The second laser range finder 22 is disposed at a second relative position with respect to the two position measurement instruments 21. The second laser range finder 22 emits a second laser beam in a distance measurement direction and measures a distance. Specifically, the second laser range finder 22 has a function as a laser pointer that emits the second laser beam visible by humans and also has a function of measuring a distance from an irradiation position irradiated with the second laser beam. The second measurement device 20 is attachable such that the second laser range finder 22 is located on a second portion (e.g. on the roof 42a of the excavation machine 40) where a positional relationship with the first portion of the object (e.g. the blade edge of the working unit 43 of the excavation machine 40) does not change.

As shown in FIG. 1, the second laser range finder 22 is installed to measure a horizontal distance Lₓ from the second laser range finder 22 to the panel 12. For example, the second laser range finder 22 may be installed to measure the horizontal distance Lₓ from the intersection between the vertical mark MK1 and the horizontal mark MK2 of the panel 12 (see FIG. 2A). Specifically, after disposing the second measurement device 20 including the second laser range finder 22, the worker determines whether or not the panel 12 is irradiated with a laser beam emitted from the second laser range finder 22. In a case where it is determined that the panel 12 is not irradiated with the laser beam, the worker changes a position and posture of the second laser range finder 22. At this time, the worker can also change a position and posture of the first laser range finder 11 as necessary. Specifically, in a case where the second laser range finder 22 is installed such that the distance measurement direction is horizontal and the intersection between the vertical mark MK1 and the horizontal mark MK2 of the panel 12 is irradiated with the second laser beam, the worker does not change the position or posture of the first laser range finder 11. In a case where the second laser range finder 22 is installed such that the distance measurement direction is horizontal and only the horizontal mark MK2 of the panel 12 is irradiated with the second laser beam, the worker changes the posture of the second laser range finder 22 in a direction (yaw direction) that rotates about the vertical direction such that the vertical mark MK1 is also irradiated with the second laser beam. In a case where the second laser range finder 22 is installed such that the distance measurement direction is horizontal and only the vertical mark MK1 of the panel 12 is irradiated with the second laser beam, the worker adjusts the height of the first laser range finder 11 such that the horizontal mark MK2 is also irradiated with the second laser beam. By repeating this, in a case where it is determined that the panel 12 is irradiated with the laser beam, installation of the second laser range finder 22 is completed, and the second laser range finder 22 can measure the horizontal distance Lₓ.

Returning to FIGS. 3A and 3B, the orientation measurement instrument 23 measures an orientation (distance measurement orientation) in the distance measurement direction of the second laser range finder 22. Specifically, the orientation measurement instrument 23 measures the distance measurement orientation when the second laser range finder 22 is disposed to measure the horizontal distance Lₓ as described above.

The second jig 24 is provided with the two position measurement instruments 21 and the second laser range finder 22. Therefore, the two position measurement instruments 21 and the second laser range finder 22 are integrated, and relative positions thereof are kept constant. The second jig 24 may further be provided with the orientation measurement instrument 23. The second jig 24 is attached to the movable object (e.g. the excavation machine 40). For example, the second jig 24 may be attached by being placed on the roof 42a of the main body unit 42 of the excavation machine 40. A position or posture of the second jig 24 can be changed by the adjustment mechanism 25 described in detail later without changing the second relative position.

The second jig 24 may include a base portion 241 and a leg portion 242.

The base portion 241 may be, for example, a plate-like member. The two position measurement instruments 21 and the second laser range finder 22 may be fixedly provided on the base portion 241. The orientation measurement instrument 23 may be fixedly provided on the base portion 241. Thus, the second laser range finder 22 is disposed at the second relative position with respect to the two position measurement instruments 21. Therefore, an absolute position of the second laser range finder 22 can be calculated on the basis of the absolute positions of the two position measurement instruments 21. In the example of FIGS. 3A and 3B, the second laser range finder 22 is provided between the two position measurement instruments 21. In this case, the absolute position of the second laser range finder 22 may be calculated to be provided between the two position measurement instruments 21.

The leg portion 242 is a member that is provided on the base portion 241 on the side opposite to the side on which the two position measurement instruments 21 and the second laser range finder 22 are provided and is attached to the movable object (e.g. the excavation machine 40). The leg portion 242 may have an elastic body 242a. The elastic body 242a may be attached to abut on the adjustment mechanism 25. The elastic body 242a may be rubber, a spring, or the like. The elastic body 242a functions as an anti-vibration mechanism that reduces transmission of vibration of the excavation machine 40 to the two position measurement instruments 21, the second laser range finder 22, the orientation measurement instrument 23, and the like. Therefore, even in a case where the excavation machine 40 is in an environment with poor workability, the second measurement device 20 is stably attached to the excavation machine 40 and can stably measure the absolute positions of the position measurement instruments 21.

The adjustment mechanism 25 changes the positions and postures of the two position measurement instruments 21 and the second laser range finder 22 while maintaining the second relative position. For example, the adjustment mechanism 25 may change a position or posture of the base portion 241 on which the two position measurement instruments 21 and the second laser range finder 22 are provided. The adjustment mechanism 25 can include a rotation mechanism 25a or a displacement mechanism 25b.

The rotation mechanism 25a changes the postures of the two position measurement instruments 21 and the second laser range finder 22. For example, the rotation mechanism 25a may change the posture of the base portion 241 on which the two position measurement instruments 21 and the second laser range finder 22 are provided. Specifically, the rotation mechanism 25a may change the postures of the two position measurement instruments 21 and the second laser range finder 22 by rotating the base portion 241 in a direction indicated by an arrow RT in FIG. 3A about an axis (y axis in the example of FIG. 3A) orthogonal to the distance measurement direction of the second laser range finder 22 (x-axis direction in the example of FIG. 3A) and to a direction of a straight line passing through the two position measurement instruments 21 (z-axis direction in the example of FIG. 3A). The rotation mechanism 25a may also change the postures of the two position measurement instruments 21 and the second laser range finder 22 by rotating the base portion 241 about the axis (z axis in the example of FIG. 3A) passing through the two position measurement instruments 21. The rotation mechanism 25a may be configured to displace the base portion 241 by any mechanism.

The displacement mechanism 25b changes the positions of the two position measurement instruments 21 and the second laser range finder 22. For example, the displacement mechanism 25b may change the position of the base portion 241 on which the two position measurement instruments 21 and the second laser range finder 22 are provided. Specifically, as shown in FIG. 3B, the displacement mechanism 25b may change the position of the base portion 241 by moving the base portion 241 in the direction of the straight line passing through the two position measurement instruments 21 (z-axis direction in the example of FIG. 3A). The displacement mechanism 25b may be configured to rotate the two position measurement instruments 21 and the second laser range finder 22 by any mechanism.

### <Configuration of Information Processing Device>

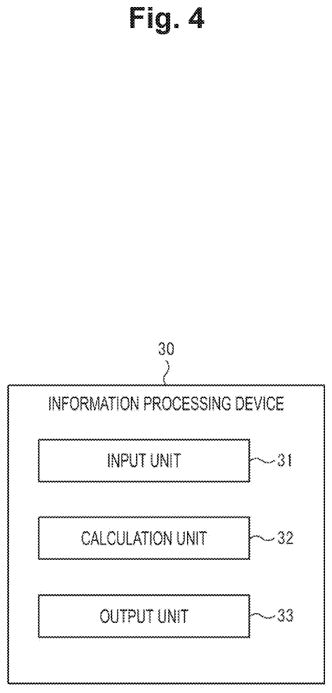

As shown in FIG. 4, the information processing device 30 includes an input unit 31, a calculation unit 32, and an output unit 33.

The input unit 31 includes an input interface. The input interface may include a pointing device, a keyboard, a mouse, or the like. The input interface may include a communication interface. For the communication interface, for example, a standard such as Ethernet (registered trademark), fiber distributed data interface (FDDI), or Wi-Fi (registered trademark) may be used. The calculation unit 32 includes a controller. The controller may include dedicated hardware such as an application specific integrated circuit (ASIC) or a field-programmable gate array (FPGA), may include a processor, or may include both thereof. The output unit 33 includes an output interface. The output interface may include a display interface or may include a communications interface. The display interface may be an organic electro luminescence (EL), a liquid crystal panel, or the like.

The input unit 31 receives input of the vertical distance L_{y} from the first measurement device 10. The input unit 31 may receive input of the vertical distance L_{y} from the first measurement device 10 via a wired or wireless communication network or may receive input of the vertical distance L_{y} by the worker's operation. The input unit 31 receives input of the absolute positions of the two position measurement instruments 21, the horizontal distance Lₓ, and the distance measurement direction from the second measurement device 20. The input unit 31 may receive input of the absolute positions of the two position measurement instruments 21, the horizontal distance Lₓ, and the distance measurement orientation from the second measurement device 20 via a wired or wireless communication network or may receive input of the absolute positions of the two position measurement instruments 21, the horizontal distance Lₓ, and the distance measurement orientation by the worker's operation.

The calculation unit 32 calculates the absolute position Pc of the target on the basis of the absolute positions of the two position measurement instruments 21, the vertical distance L_{y} from the first laser range finder 11 to the target measured by the first laser range finder 11, the horizontal distance Lₓ: from the second laser range finder 22 to the panel 12 measured by the second laser range finder 22, the first relative position, and the distance measurement orientation (orientation in the distance measurement direction) of the second laser range finder 22 in a state in which the second laser range finder 22 is attached to the second portion (e.g. the roof 42a of the excavation machine 40) where a positional relationship with the first portion (e.g. the blade edge of the excavation machine 40) of the above object (e.g. the excavation machine 40) does not change.

Specifically, first, the calculation unit 32 calculates the second relative position with respect to the absolute positions of the two position measurement instruments 21 as the absolute position of the second laser range finder 22. For example, in a configuration in which the second laser range finder 22 is located between the two position measurement instruments 21 as described above, the calculation unit 32 calculates the position between the absolute positions of the two position measurement instruments 21 as the position of the second laser range finder 22.

Then, the calculation unit 32 calculates, as the absolute position P₀ of the target, a position apart from a position that is the first relative position (the position of the first laser range finder 11) by the vertical distance L_{y} in the vertical direction of the first laser range finder 11 with respect to a position (the position of the panel 12) apart from the second laser range finder 22 by the horizontal distance Lₓ in the horizontal direction of the distance measurement orientation.

The calculation unit 32 may calculate the absolute position P₀ of the target after the object moves on the basis of the absolute positions of the two position measurement instruments 21 measured after the horizontal distance Lₓ and the vertical distance L_{y} are measured and then the object moves. Specifically, the calculation unit 32 calculates, as the absolute position of the second laser range finder 22, the second relative position with respect to the absolute positions of the two position measurement instruments 21 measured after the object moves. Then, the calculation unit 32 may calculate an absolute position P₁ of the target after the object moves on the basis of the absolute position of the second laser range finder 22 and the already measured horizontal distance Lₓ and vertical distance L_{y}. For example, the calculation unit 32 calculates, as the absolute position P₁ of the target after the object moves, the position apart from the position that is the first relative position (the position of the first laser range finder 11) by the vertical distance L_{y} in the vertical direction with respect to the position (the position of the panel 12) apart from the second laser range finder 22 by the horizontal distance Lₓ in the horizontal direction of the distance measurement orientation.

### <Measurement Using Measurement System>

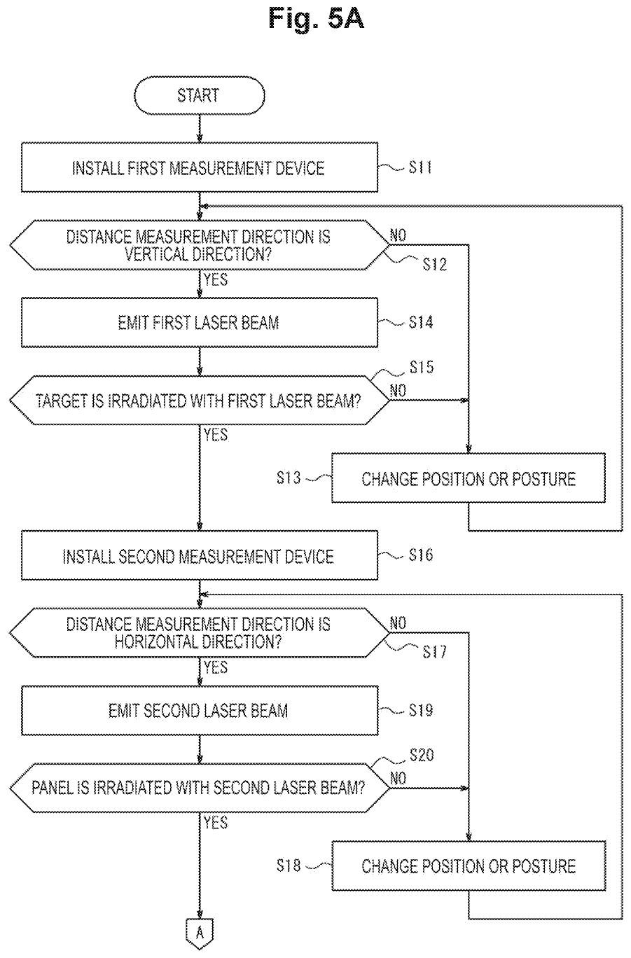

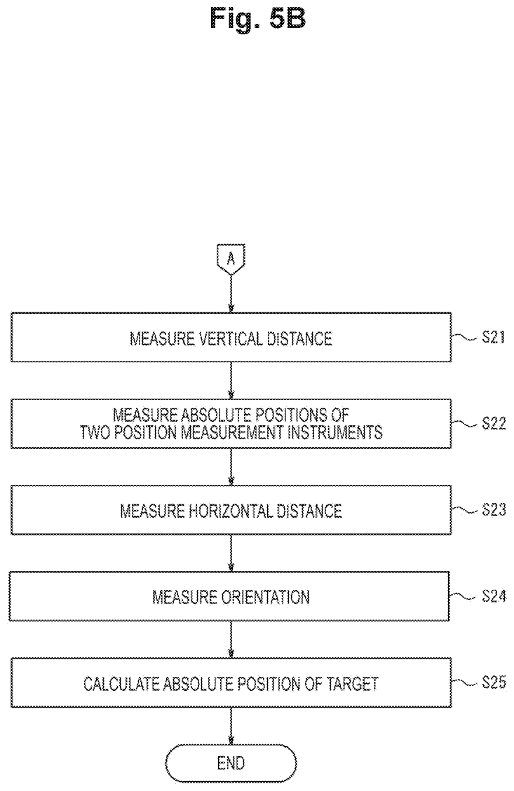

Next, an example of measurement using the measurement system 100 according to the present embodiment will be described with reference to FIGS. 5A and 5B. FIGS. 5A and 5B are flowcharts showing the example of the measurement using the measurement system 100 that measures the absolute position P₀ of the target that is the first portion of the movable object according to the present embodiment. The example of the measurement using the measurement system 100 described with reference to FIGS. 5A and 5B corresponds to a measurement method according to the present embodiment.

In steps S11 to S15, the first measurement device 10 including the first laser range finder 11 and the panel 12 disposed at the first relative position with respect to the first laser range finder 11 is installed such that the first laser range finder 11 can measure the vertical distance L_{y}, from the target.

Specifically, as shown in FIG. 5A, the first measurement device 10 is installed in step S11.

In step S12, it is determined whether or not the distance measurement direction of the first laser range finder 11 is the vertical direction.

If it is determined in step S12 that the distance measurement direction is not the vertical direction, the position and posture of the first laser range finder 11 are changed in step S13.

If it is determined in step S12 that the distance measurement direction is the vertical direction, the first laser range finder 11 is caused to emit a first laser beam in step S14.

In step S15, it is determined whether or not the target is irradiated with the first laser beam.

If it is determined in step S15 that the target is not irradiated with the first laser beam, the processing proceeds to step S13.

If it is determined in step S15 that the target is irradiated with the first laser beam, in steps S16 to S20, the second measurement device 20 including the two position measurement instruments 21 that measure their respective absolute positions by using signals received from a satellite and are disposed at different positions and the second laser range finder 22 disposed at the second relative position with respect to the two position measurement instruments 21 is installed such that the second laser range finder 22 can measure the horizontal distance Lₓ from the panel 12.

Specifically, the second measurement device 20 is installed in step S16.

In step S17, the level 14 determines whether or not the distance measurement direction of the second laser range finder 22 is the horizontal direction.

If it is determined in step S17 that the distance measurement direction of the second laser range finder 22 is not the horizontal direction, the position and posture of the second laser range finder 22 are changed in step S18.

If it is determined in step S17 that the distance measurement direction of the second laser range finder 22 is the horizontal direction, the second laser range finder 22 is caused to emit a second laser beam in step S19.

In step S20, it is determined whether or not the panel 12 is irradiated with the second laser beam. Specifically, it is determined whether or not the intersection between the vertical mark MK1 and the horizontal mark MK2 of the panel 12 is irradiated with the second laser beam.

If it is determined in step S20 that the panel 12 is not irradiated with the second laser beam, the processing proceeds to step S18. Specifically, if it is determined that the intersection between the vertical mark MK1 and the horizontal mark MK2 of the panel 12 is not irradiated with the second laser beam, the processing proceeds to step S18. When the processing proceeds from step S20 to step S18, not only the position and posture of the second laser range finder 22 but also the position and posture of the first laser range finder 11 may be changed in step S18 as described above.

If it is determined in step S20 that the panel 12 is irradiated with the second laser beam, as shown in FIG. 5B, the vertical distance L_{y} is measured by the first laser range finder 11 in step S21. Specifically, if it is determined that the intersection between the vertical mark MK1 and the horizontal mark MK2 of the panel 12 is irradiated with the second laser beam, the vertical distance L_{y} is measured by the first laser range finder 11 in step S21.

In step S22, the absolute positions of the two position measurement instruments 21 are measured.

In step S23, the horizontal distance Lₓ is measured by the second laser range finder 22.

In step S24, the orientation in the distance measurement direction of the second laser range finder 22 is measured.

In step S25, the calculation unit 32 of the information processing device 30 calculates the absolute position P₀ of the target on the basis of the absolute positions of the two position measurement instruments 21, the vertical distance L_{y} from the first laser range finder 11 to the target measured by the first laser range finder 11, the horizontal distance Lₓ from the second laser range finder 22 to the panel 12 measured by the second laser range finder 22, the first relative position, and the orientation in the distance measurement direction of the second laser range finder 22.

Thereafter, the output unit 33 of the information processing device 30 may output the absolute position P₀ of the target. In the above operation, steps S22, S24, and S25 may be repeated after the horizontal distance Lₓ and the vertical distance L_{y} are measured and the object (e.g. the excavation machine 40) moves. In this case, the information processing device 30 can calculate the absolute position P₁ of the target after the object moves. In the above operation, steps S21 to S24 may be executed in any order. Any two or more of steps S21 to S24 may be executed at the same timing.

As described above, according to the present embodiment, the measurement system 100 includes the first measurement device 10, the second measurement device 20, and the information processing device 30 and measures the absolute position P₀ of the target that is the first portion of the movable object. The first measurement device 10 includes the first laser range finder 11 that irradiates a distance measurement direction and measures a distance and the panel 12 disposed at the first relative position with respect to the first laser range finder 11. The second measurement device 20 includes the two position measurement instruments 21 that measure their respective absolute positions by using signals received from a satellite and are disposed at different positions and the second laser range finder 22 that is disposed at the second relative position with respect to the two position measurement instruments 21, irradiates a distance measurement direction, and measures a distance. The information processing device 30 includes the calculation unit 32 that calculates the absolute position P₁ of the target on the basis of the absolute positions of the two position measurement instruments 21, the vertical distance L_{y} from the first laser range finder 11 to the target measured by the first laser range finder 11, the horizontal distance Lₓ from the second laser range finder 22 to the panel 12 measured by the second laser range finder 22, the first relative position, and the orientation in the distance measurement direction of the second laser range finder 22 in a state in which the second laser range finder 22 is attached to the second portion where a positional relationship with the first portion of the object does not change.

Therefore, the measurement system 100 can measure the absolute position P₀ of the target with high accuracy. The measurement system 100 calculates the absolute position P₀ of the target without depending on attachment accuracy of the position measurement instruments 21, and thus it is possible to suppress a decrease in measurement accuracy of the absolute position P₀ of the target due to a human error even in an environment with poor workability. The measurement system 100 can measure the absolute position P₁ of the second portion of the excavation machine 40 (e.g. the blade edge of the trencher) along with movement of the excavation machine 40. This makes it possible to assume an absolute position of a pipeline or the like laid at a place excavated by the second portion. In a case where a GNSS receiver and a ranging rod are used as in the related art, the absolute position of the pipeline or the like is measured at intervals of about one point in several tens of meters from the viewpoint of the workload, whereas the measurement system 100 of the present embodiment can measure the absolute position P₁ of the target at any interval along with the movement of the excavation machine 40. For example, the measurement system 100 can easily measure the absolute position P₁ at intervals of one point in several millimeters to several centimeters. This makes it possible to create a drawing showing the position of the pipeline or the like in the ground A with high accuracy.

### (First Modification)

In the above embodiment, the second measurement device 20 may not include the orientation measurement instrument 23. In such a configuration, the calculation unit 32 may calculate the distance measurement orientation of the second laser range finder 22 on the basis of the absolute positions of the two position measurement instruments 21, the second relative position, and the direction of the straight line passing through the two position measurement instruments 21. For example, as shown in FIG. 3A, in a configuration in which the second laser range finder 22 is disposed between the two position measurement instruments 21 and is provided such that the distance measurement direction is a direction orthogonal to the straight line passing through the two position measurement instruments 21, it can be determined that the distance measurement orientation is an orientation including a direction orthogonal to the straight line passing through the two position measurement instruments 21 from the position between the two position measurement instruments 21. According to a first modification, the second measurement device 20 may not include the orientation measurement instrument 23 and thus may be configured simply.

### (Second Modification)

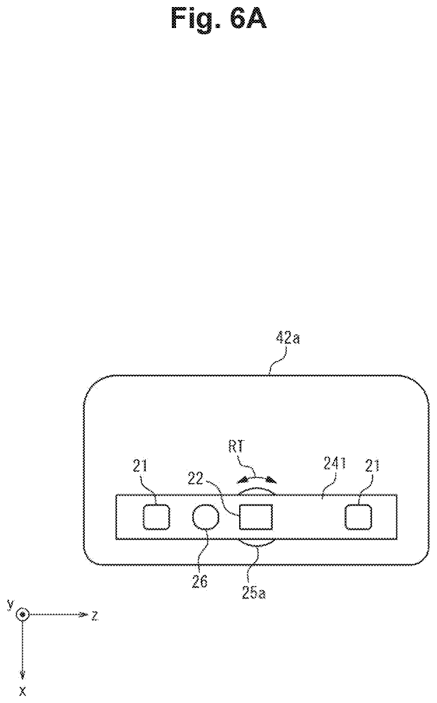

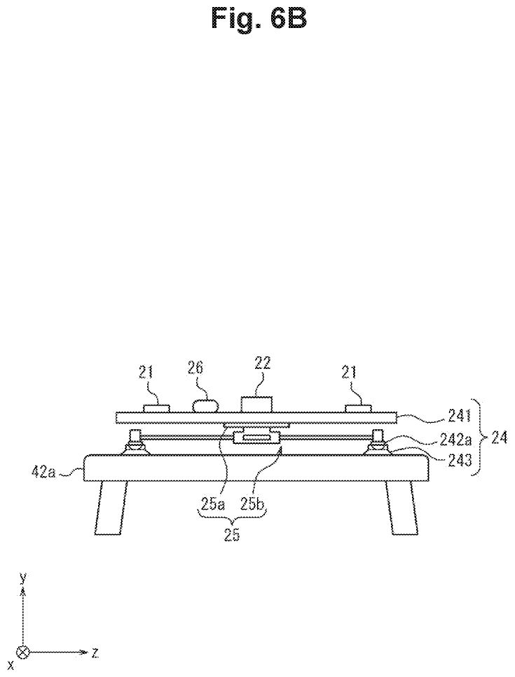

In the above embodiment, as shown in FIGS. 6A and 6B, the second measurement device 20 may further include an inclination angle sensor 26. The inclination angle sensor 26 may be provided on the base portion 241. In the present modification, the second measurement device 20 may include the orientation measurement instrument 23 or may not include the orientation measurement instrument as in the example of FIGS. 6A and 6B.

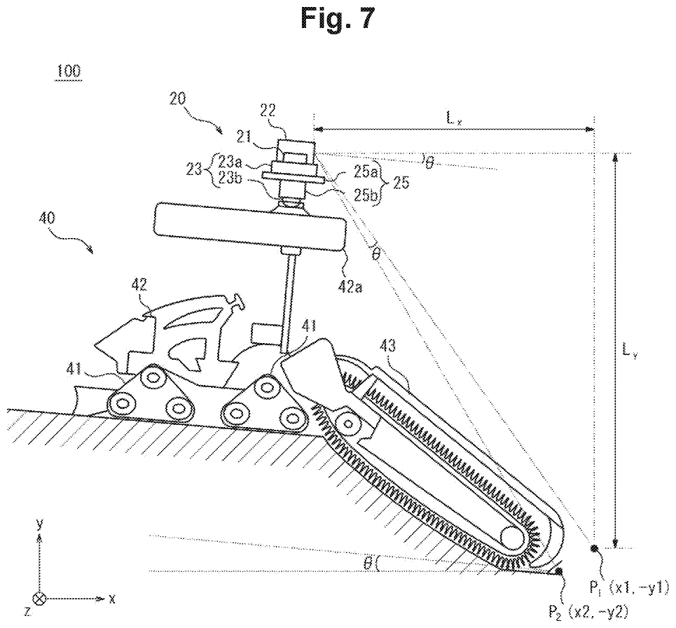

The inclination angle sensor 26 measures an inclination angle θ with respect to the horizontal direction in the distance measurement direction of the second laser range finder 22 after the horizontal distance Lₓ and the vertical distance L_{y} are measured and the object (e.g. the excavation machine 40) moves. As described above, when the horizontal distance Lₓ and the vertical distance L_{y} are measured, the second measurement device 20 is installed such that the distance measurement direction of the second laser range finder 22 is the horizontal direction. However, when the object moves thereafter, the object may be located on a ground surface inclined at an inclination angle, the ground surface being different from a ground surface when the horizontal distance Lₓ and the vertical distance L_{y} are measured. In such a case, the distance measurement direction is inclined with respect to the horizontal direction as shown in FIG. 7. The inclination angle sensor 26 measures the inclination angle θ with respect to the horizontal direction in the distance measurement direction of the second laser range finder 22.

In the second modification, the calculation unit 32 calculates the absolute position P₀ of the target after the object moves on the basis of the absolute positions of the two position measurement instruments 21 and the inclination angle θ measured after the horizontal distance Lₓ and the vertical distance L_{y} are measured and then the object moves.

For example, the calculation unit 32 calculates coordinates (x₂, −y₂) of a position P₂ of the target on an xy plane in a case where the position of the second laser range finder 22 is set as the origin, the horizontal direction is set as the x-axis direction, and the vertical direction is set as the y-axis direction.

Specifically, the calculation unit 32 calculates the x coordinate x₂ of the position P₂ of the target from Equation (1). In Equation (1), x₁ is an x coordinate at a position apart from the second laser range finder 22 by the above horizontal distance Lₓ in the horizontal direction of the distance measurement orientation in a case where the position of the second laser range finder 22 is set as the origin. Further, y₁ is a y coordinate at a position apart from the second laser range finder 22 by the above vertical distance L_{y} in the vertical direction in a case where the position of the second laser range finder 22 is set as the origin. In a configuration in which the second measurement device 20 does not include the orientation measurement instrument 23, the distance measurement orientation is measured as described in the first modification. In a configuration in which the second measurement device 20 includes the orientation measurement instrument 23, the distance measurement orientation is measured by the orientation measurement instrument 23.

$${x}_{2} = {x}_{1} cos ( - θ ) - {y}_{1} sin ( - θ ) \qquad ( 1 )$$

The calculation unit 32 calculates a y coordinate y₂ of the position P₂ of the target from Equation (2).

$${y}_{2} = {x}_{1} sin ( - θ ) + {y}_{1} cos ( - θ ) \qquad ( 2 )$$

Then, the calculation unit 32 calculates the absolute position P: of the target on the basis of the absolute position of the second laser range finder 22 and the coordinates (x₂, −y₂) of the position P: of the target when the absolute position is set as the origin. Specifically, the calculation unit 32 calculates, as the absolute position P₂ of the target, a position apart from the position that is the first relative position by the distance y₂ in the vertical downward direction with respect to a position apart from the second laser range finder 22 by the distance x₂ in the horizontal direction that is the distance measurement orientation of the second laser range finder 22.

According to the second modification, the inclination angle sensor 26 that measures the inclination angle θ of the distance measurement direction of the second laser range finder 22 with respect to the horizontal direction is further included, and the calculation unit 32 calculates the absolute position P₂ of the target after the object moves on the basis of the absolute positions of the two position measurement instruments 21, the horizontal distance Lₓ, the vertical distance L_{y}, and the inclination angle θ measured after the horizontal distance L and the vertical distance L_{y} are measured and then the object moves. Therefore, the measurement system 100 can measure the absolute position P: of the target with high accuracy even in a case where the excavation machine 40 travels on a non-flat ground surface.

### <Program>

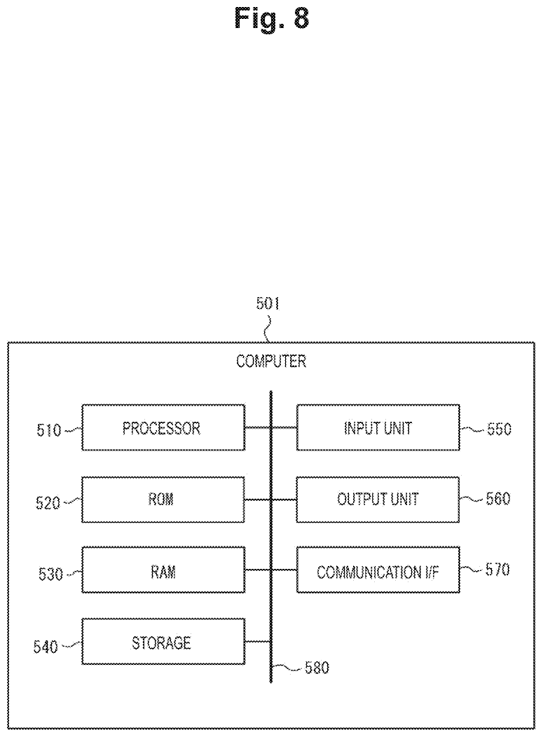

The information processing device 30 described above can be implemented by a computer 501. Further, a program for causing the computer to function as the information processing device 30 described above may be provided. The program may be stored in a storage medium or may be provided via a network. FIG. 8 is a block diagram showing a schematic configuration of the computer 501 functioning as the information processing device 30. Here, the computer 501 may be a general-purpose computer, a dedicated computer, a workstation, a personal computer (PC), an electronic notepad, or the like. Program instructions may be program codes, code segments, or the like for performing required tasks.

As shown in FIG. 8, the computer 501 includes a processor 510, a read only memory (ROM) 520, a random access memory (RAM) 530, a storage 540, an input unit 550, an output unit 560, and a communication interface (I/F) 570. The components are communicably connected to each other via a bus 580. Specifically, the processor 510 is a central processing unit (CPU), a micro processing unit (MPU), a graphics processing unit (GPU), a digital signal processor (DSP), a system on a chip (SoC), or the like and may include a plurality of processors of the same or different types.

The processor 510 executes control on the components and various types of arithmetic processing. That is, the processor 510 reads the program from the ROM 520 or the storage 540 and executes the program by using the RAM 530 as a work area. The processor 510 performs control on the components and various types of arithmetic processing in accordance with the program stored in the ROM 520 or the storage 540. In the embodiments described above, the program according to the present disclosure is stored in the ROM 520 or the storage 540.

The program may be stored in a storage medium readable by the computer 501. By using such a storage medium, it is possible to install the program in the computer 501. Here, the storage medium in which the program is stored may be a non-transitory storage medium. The non-transitory storage medium is not particularly limited, but may be, for example, a CD-ROM, a DVD-ROM, or a universal serial bus (USB) memory. The program may be downloaded from an external device via a network.

The ROM 520 stores various programs and various frames. The RAM 530 temporarily stores a program or frame as a working area. The storage 540 includes a hard disk drive (HDD) or a solid state drive (SSD) and stores various programs including an operating system and various frames.

The input unit 550 includes one or more input interfaces that receive a user's input operation and acquire information based on the user's operation. For example, the input unit 550 is a pointing device, a keyboard, a mouse, or the like, but is not limited thereto.

The output unit 560 includes one or more output interfaces that output information. The output unit 560 is a display that outputs information as video images or a speaker that outputs information as sound, for example, but is not limited thereto. The output unit 560 also functions as the input unit 550 in a case where the output unit is a touch panel display.

The communication interface (I/F) 570 is an interface for communicating with an external device.

Regarding the above embodiment, the following supplementary notes are further disclosed.

### [Supplementary Note 1]

A measurement system that includes a first measurement device, a second measurement device, and an information processing device and measures an absolute position of a target that is a first portion of a movable object, in which:
the first measurement device includes
a first laser range finder that irradiates a distance measurement direction and measures a distance, and
a panel disposed at a first relative position with respect to the first laser range finder;
the second measurement device includes
two position measurement instruments that measure respective absolute positions by using signals received from a satellite and are disposed at different positions, and
a second laser range finder that is disposed at a second relative position with respect to the two position measurement instruments, irradiates a distance measurement direction, and measures a distance;
the information processing device includes a controller; and
the controller calculates the absolute position of the target on the basis of the absolute positions of the two position measurement instruments, a vertical distance from the first laser range finder to the target measured by the first laser range finder, a horizontal distance from the second laser range finder to the panel measured by the second laser range finder, the first relative position, and an orientation in the distance measurement direction of the second laser range finder in a state in which the second laser range finder is attached to a second portion where a positional relationship with the first portion of the object does not change.

### [Supplementary Note 2]

The measurement system according to supplementary note 1, in which
the second measurement device further includes a second jig in which the two position measurement instruments and the second laser range finder are installed and can change a position or posture of the second jig without changing the second relative position.

### [Supplementary Note 3]

The measurement system according to supplementary note 1 or 2, in which
the controller calculates the second relative position with respect to the absolute positions of the two position measurement instruments as an absolute position of the second laser range finder and calculates, as the absolute position of the target, a position apart from a position that is the first relative position by the vertical distance in the vertical direction with respect to a position apart from the second laser range finder by the horizontal distance in a horizontal direction of the orientation.

### [Supplementary Note 4]

The measurement system according to any one of supplementary notes 1 to 3, further including
an inclination angle sensor that measures an inclination angle of the distance measurement direction of the second laser range finder with respect to a horizontal direction, in which
the controller calculates the absolute position of the target after the object moves on the basis of the absolute positions of the two position measurement instruments, the horizontal distance, the vertical distance, and the inclination angle measured after the horizontal distance and the vertical distance are measured and then the object moves.

### [Supplementary Note 5]

A measurement method using a measurement system for measuring an absolute position of a target that is a first portion of a movable object, the measurement method including:
installing a first measurement device including a first laser range finder and a panel disposed at a first relative position with respect to the first laser range finder such that the first laser range finder can measure a vertical distance from the target;
installing a second measurement device including two position measurement instruments that measure respective absolute positions by using signals received from a satellite and are disposed at different positions and a second laser range finder disposed at a second relative position with respect to the two position measurement instruments such that the second laser range finder can measure a horizontal distance from the panel;
measuring the vertical distance by the first laser range finder;
measuring the absolute positions of the two position measurement instruments;
measuring the horizontal distance by the second laser range finder; and
calculating the absolute position of the target on the basis of the absolute positions of the two position measurement instruments, the vertical distance from the first laser range finder to the target measured by the first laser range finder, the horizontal distance from the second laser range finder to the panel measured by the second laser range finder, the first relative position, and an orientation in a distance measurement direction of the second laser range finder.

### [Supplementary Note 6]

The measurement method according to supplementary note 5, in which
disposing the first measurement device includes
causing the first laser range finder to emit a first laser beam,
determining whether or not the target is irradiated with the first laser beam, and
changing a position and posture of the first laser range finder in a case where it is determined that the target is not irradiated with the first laser beam.

### [Supplementary Note 7]

The measurement method according to supplementary note 5 or 6, in which
disposing the second measurement device includes
causing the second laser range finder to emit a second laser beam,
determining whether or not the panel is irradiated with the second laser beam, and
changing a position and posture of the second laser range finder in a case where it is determined that the panel is not irradiated with the second laser beam.

All the literatures, patent applications, and techniques mentioned in this specification are incorporated herein by reference to the same extent as if each individual literature, patent application, and technique were specifically and individually described to be incorporated by reference.

Although the above-described embodiment has been described as a representative example, it is apparent to those skilled in the art that many changes and substitutions can be made within the spirit and scope of the present disclosure. Thus, it should not be understood that the present invention is limited by the above-described embodiments, and various modifications or changes can be made without departing from the scope of the claims.

### REFERENCE SIGNS LIST

10 First measurement device
20 Second measurement device
30 Information processing device
10 First measurement device
11 First laser range finder
12 Panel
13 First jig
14 Level
14a Planar member
20 Second measurement device
21 Position measurement instrument
22 Second laser range finder
23 Orientation measurement instrument
24 Second jig
25 Inclination angle sensor
26 Rotation mechanism
27 Displacement mechanism
30 Information processing device
31 Input unit
32 Calculation unit
33 Output unit
40 Excavation machine
41 Traveling unit
42 Main body unit
42a Roof
43 Working unit
100 Measurement system
131 Main column portion
132 Support column portion
133 Support portion
241 Base portion
242 Leg portion
242 Adjustment mechanism
242a Rotation mechanism
242b Displacement mechanism
501 Computer
510 Processor
520 ROM
530 RAM
540 Storage
550 Input unit
560 Output unit
570 Communication interface
580 Bus

1. A measurement system for measuring an absolute position of a target that is a first portion of a movable object, comprising:
a first measurement device comprising a first processor executing first computer-executable instructions that performs operations comprising:
irradiating, by a first laser range finder, a distance measurement direction and measuring a distance, wherein a panel is disposed at a first relative position with respect to the first laser range finder;
a second measurement device comprising a second processor executing second computer-executable instructions that performs operations comprising:
measuring, by two position measurement instruments, respective absolute positions by using signals received from a satellite and are disposed at different positions, and
irradiating, by a second laser range finder that is disposed at a second relative position with respect to the two position measurement instruments, a distance measurement direction and measuring a distance; and
calculating, by a information processing device:
the absolute position of the target on the basis of the absolute positions of the two position measurement instruments,
a vertical distance from the first laser range finder to the target measured by the first laser range finder,
a horizontal distance from the second laser range finder to the panel measured by the second laser range finder, the first relative position, and
an orientation in the distance measurement direction of the second laser range finder in a state in which the second laser range finder is attached to a second portion where a positional relationship with the first portion of the object does not change.

2. The measurement system according to claim 1, wherein
the second measurement device further includes a second jig in which the two position measurement instruments and the second laser range finder are installed, and the second processor further performs operations comprising changing a position of the second jig without changing the second relative position.

3. The measurement system according to claim 1, wherein
the calculating further comprises:
calculating the second relative position with respect to the absolute positions of the two position measurement instruments as an absolute position of the second laser range finder and
further calculating, as the absolute position of the target, a position apart from a position that is the first relative position by the vertical distance in the vertical direction with respect to a position apart from the second laser range finder by the horizontal distance in a horizontal direction of the orientation.

4. The measurement system according to claim 1, the first processor further executes the first executable instructions that performs operations comprising
measuring, by an inclination angle sensor, an inclination angle of the distance measurement direction of the second laser range finder with respect to a horizontal direction, wherein
the calculating further comprises calculating the absolute position of the target after the object moves on the basis of the absolute positions of the two position measurement instruments, the horizontal distance, the vertical distance, and the inclination angle measured after the horizontal distance and the vertical distance are measured and then the object moves.

5. A measurement method using a measurement system for measuring an absolute position of a target that is a first portion of a movable object, comprising:
installing a first measurement device, wherein the first measurement device comprises a first laser range finder and a panel disposed at a first relative position with respect to the first laser range finder, and the first laser range finder measures a vertical distance from the target;
installing a second measurement device, wherein the second measurement device comprises two position measurement instruments that measure respective absolute positions by using signals received from a satellite, and the two position measurement instruments are disposed at different positions and a second laser range finder disposed at a second relative position with respect to the two position measurement instruments, and the second laser range finder measures a horizontal distance from the panel;
measuring the vertical distance by the first laser range finder;
measuring the absolute positions of the two position measurement instruments;
measuring the horizontal distance by the second laser range finder; and
calculating;
the absolute position of the target on the basis of the absolute positions of the two position measurement instruments,
the vertical distance from the first laser range finder to the target measured by the first laser range finder,
the horizontal distance from the second laser range finder to the panel measured by the second laser range finder,
the first relative position, and
an orientation in a distance measurement direction of the second laser range finder.

6. The measurement method according to claim 5, the installing the second measurement device further comprises:
causing the first laser range finder to emit a first laser beam,
determining whether or not the target is irradiated with the first laser beam, and
when the target is not irradiated with the first laser beam, changing a position and posture of the first laser range finder.

7. The measurement method according to claim 5, wherein the installing the second measurement device further comprises:
causing the second laser range finder to emit a second laser beam,
determining whether or not the panel is irradiated with the second laser beam, and
changing a position and posture of the second laser range finder in a case where it is determined that the panel is not irradiated with the second laser beam.
